(19) United States
(12) Patent Application Publication
(10) Pub. No.: US 2025/0310499 A1
(43) Pub. Date: Oct. 2, 2025

(54) UNIVERSAL ARTIFICIAL INTELLIGENCE (AI) AUTOMATIC WHITE BALANCE (AWB)

(71) Applicant: QUALCOMM Incorporated, San Diego, CA (US)

(72) Inventors: Tsung-Yen CHEN, Taichung City (TW); Yi-Chun HSU, Taipei City (TW); Wei-Chih LIU, Taipei City (TW); Wen-Chun FENG, New Taipei City (TW)

(21) Appl. No.: 18/617,475

(22) Filed: Mar. 26, 2024

(51) Int. Cl. H04N 9/73; G06T 7/90

(52) U.S. Cl. CPC H04N 9/73; G06T 7/90

(57) ABSTRACT

Systems and techniques are described herein for image processing. For example, a computing device can apply an initial white balance (WB) gain and an initial color correction matrix (CCM) to a raw image of a scene to produce a color image. The computing device can generate, using a machine learning model, an estimated gain of at least one color component based on the color image. The computing device can determine a resultant WB gain based on an inverse of the initial WB gain. The computing device can apply the resultant WB gain to the raw image to produce a resultant image.

### FIELD

The present disclosure generally relates to image processing. For example, aspects of the present disclosure relate to a universal artificial intelligence (AI) automatic white balance (AWB).

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

For image processing, an automatic white balance (AWB) can also be utilized in image processing to determine the AWB gain for an image, which can determine the neutral color of the image. The goal of an AWB is to make the color of the image (e.g., of an image frame) balanced with respect to a reference white point.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for image processing. According to at least one example, an apparatus for image processing is provided. The apparatus includes at least one memory and at least one processor coupled to the at least one memory and configured to: apply an initial white balance (WB) gain and an initial color correction matrix (CCM) to a raw image of a scene to produce a color image; generate, using a machine learning model, an estimated gain of at least one color component based on the color image; determine a resultant WB gain based on an inverse of the initial WB gain; and apply the resultant WB gain to the raw image to produce a resultant image.

In another illustrative example, a method is provided for image processing. The method includes: applying an initial white balance (WB) gain and an initial color correction matrix (CCM) to a raw image of a scene to produce a color image; generating, using a machine learning model, an estimated gain of at least one color component based on the color image; determining a resultant WB gain based on an inverse of the initial WB gain; and applying the resultant WB gain to the raw image to produce a resultant image.

In another illustrative example, a non-transitory computer-readable medium is provided having stored thereon instructions that, when executed by one or more processors, cause the one or more processors to: apply an initial white balance (WB) gain and an initial color correction matrix (CCM) to a raw image of a scene to produce a color image; generate, using a machine learning model, an estimated gain of at least one color component based on the color image; determine a resultant WB gain based on an inverse of the initial WB gain; and apply the resultant WB gain to the raw image to produce a resultant image.

In another illustrative example, an apparatus for image processing is provided. The apparatus includes: means for applying an initial white balance (WB) gain and an initial color correction matrix (CCM) to a raw image of a scene to produce a color image; means for generating, using a machine learning model, an estimated gain of at least one color component based on the color image; means for determining a resultant WB gain based on an inverse of the initial WB gain; and means for applying the resultant WB gain to the raw image to produce a resultant image.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image capture and processing system, in accordance with some examples.

FIG. 2 is a block diagram illustrating an example of interactions between components of an image capture and processing system, in accordance with some examples.

FIG. 3 is a block diagram of an example device that may be used for post AEC and AWB processing to improve video quality, in accordance with some examples.

FIG. 4 is a block diagram showing the operation of an image signal processor pipeline, in accordance with some examples.

FIG. 5 is a diagram illustrating an example process of a traditional AWB algorithm, in accordance with some examples.

FIG. 6 is a diagram illustrating an example process of a traditional AWB algorithm with cumbersome finetuning, in accordance with some examples.

FIG. 7 is a diagram illustrating an example of a process of a traditional AWB algorithm utilizing different machine learning (ML) models that are camera sensor (e.g., image sensor) dependent, in accordance with some examples.

FIG. 8 is a diagram illustrating an example of a process of a universal AI AWB algorithm, in accordance with some examples.

FIG. 9 is a diagram illustrating a comparison between a traditional AWB algorithm and a universal AI AWB algorithm, in accordance with some examples.

FIG. 10 is a diagram illustrating an example of a detailed process of a universal AI AWB algorithm, in accordance with some examples.

FIG. 11 is a table illustrating a comparison of advantages and disadvantages of traditional AWB algorithms, normal AI AWB algorithms, and universal AI AWB algorithms, in accordance with some examples.

FIG. 12 is a flow diagram illustrating an example of a process for image processing, in accordance with some examples.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor (e.g., an image sensor) can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, for image processing, for example by an image signal processor, an AWB can be utilized in image processing to determine the AWB gain for an image, which can determine the neutral color of the image. The goal of an AWB is to make the color of the image (e.g., of an image frame) balanced with respect to a reference white point.

In existing image processing solutions, traditional AWB algorithms commonly use a statistics-based algorithm to perform automatic white balance. These traditional AWB algorithms require cumbersome finetuning, which consumes many resources, of the AWB algorithm parameters to achieve quality white balancing in every single different scene. Currently, more and more manufacturers of many different types of products (e.g., laptop computers, internet of things (IoT) devices, and/or automotive vehicles) desire AWB solutions that require less of a tuning effort to achieve the same quality of white balancing. Due to a sensitivity difference in the different types of camera sensors (e.g., image sensors), no single machine learning (ML) model of the existing AWB algorithms can effectively process raw images obtained from all of the different types of camera sensors. For these traditional AWB algorithms, the ML models, which use raw images as an input, have the disadvantage of needing to be retrained for each of the different types of camera sensors.

As such, improved systems and techniques for AWB that employ a universal ML model, which can be used for all different types of camera sensors and does not need to be retrained for each of the different types of camera sensors, can be beneficial.

In one or more aspects, systems, apparatuses, processes (also referred to as methods), and computer-readable media (collectively referred to herein as “systems and techniques”) are described herein for providing a universal artificial intelligence (AI) automatic white balance (AWB). In one or more examples, the systems and techniques provide an AWB solution that removes the dependency between the ML model and the type of camera sensor (e.g., image sensor). In some examples, red, green, blue (RGB) images can be used to train an ML model. The ML model can generate a predicted result, which can be converted back to produce a white balance (WB) gain. By training the ML model with RGB images, the ML model can universally be utilized for all different types of camera sensors (e.g., without having to retrain the ML model for the different types of camera sensors).

In one or more aspects, during operation of the systems and techniques for image processing, an image sensor (e.g., of a camera device) can obtain a raw image of a scene. One or more processors (e.g., of the camera device) can apply an initial white balance (WB) gain and an initial color correction matrix (CCM) to the raw image of the scene to produce a color image. In one or more examples, the initial WB gain and the initial CCM can be associated with the image sensor. In some examples, the initial WB gain and the initial CCM can be associated with an illuminance index.

In some examples, a WB gain can be a multiplier that can applied to the red, green, and blue channels of an image. The WB gain can be used to adjust the color temperature of an image such that the white objects within the image appear white under different lighting conditions. In one or more examples, the CCM can be a mathematical transformation that can map the colors in an image from one color space to another color space. The CCM can be used to correct color inaccuracies in an image caused by factors, such as lighting conditions, camera setting, and sensor characteristics. In one or more examples, the color image can be a red, green, blue (RGB) image. In some examples, the RGB image has a red component, a green component, and a blue component per pixel of the image.

The one or more processors, using a machine learning model, can generate an estimated gain of at least one color component based on the color image. In one or more examples, the estimated gain can be further based on an illuminance (lux) index for the raw image. In some examples, the estimated gain of the at least one color component can include a red gain, a green gain, and a blue gain based on the RGB image.

The one or more processors can determine a resultant WB gain based on an inverse of the initial WB gain. In one or more examples, the one or more processors can determine the inverse of the initial WB gain based on the initial WB gain divided by an inverse of the CCM applied to the estimated gain of the at least one color component. In some examples, the initial WB gain can be associated with initial RGB gains, and the resultant WB gain can be associated with resultant RGB gains. The one or more processors can apply the resultant WB gain to the raw image to produce a resultant image. A display can display the resultant image.

Additional aspects of the present disclosure are described in more detail below.

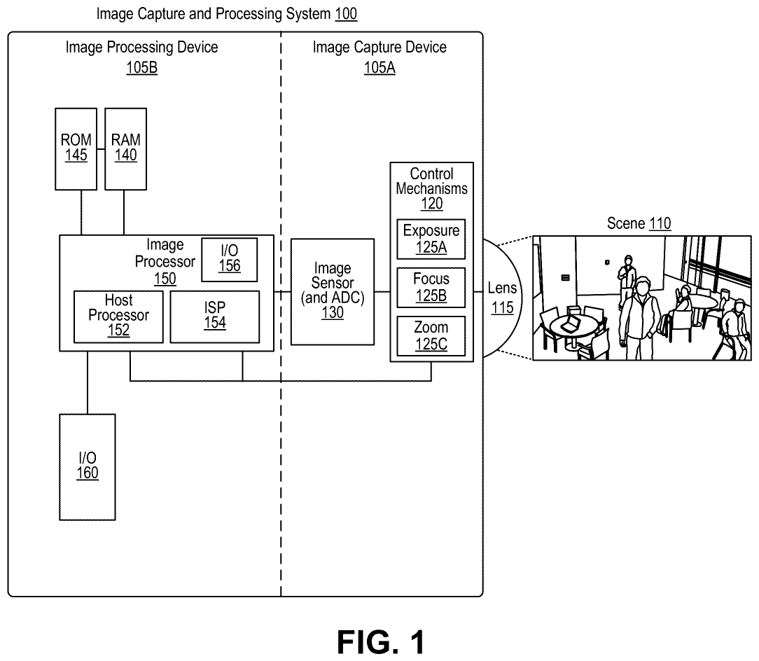

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

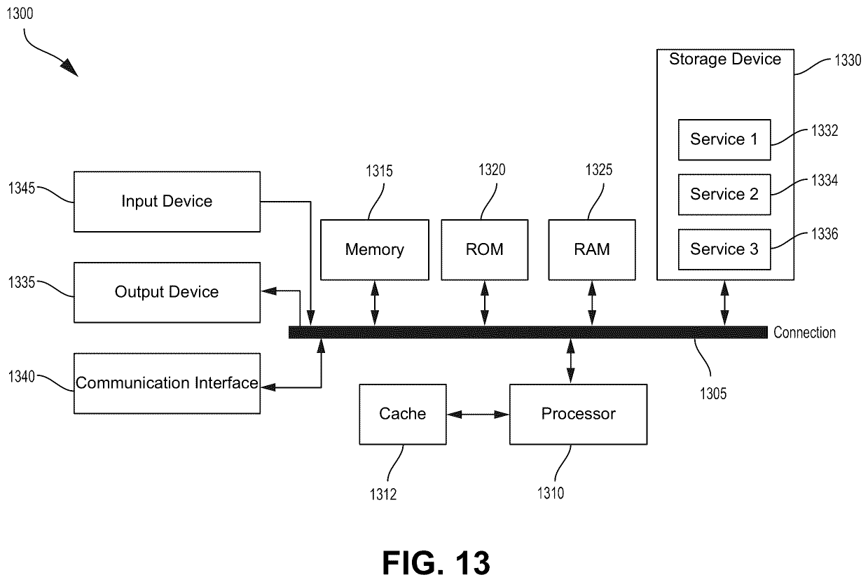

The image processor 150 may include one or more processors, such as one or more image signal processors (ISPs) (including ISP 154), one or more host processors (including host processor 152), and/or one or more of any other type of processor 1310 discussed with respect to the computing system 1300 of FIG. 13. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/820, read-only memory (ROM) 145/825, a cache 812, a memory unit 815, another storage device 830, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 835, any other input devices 845, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

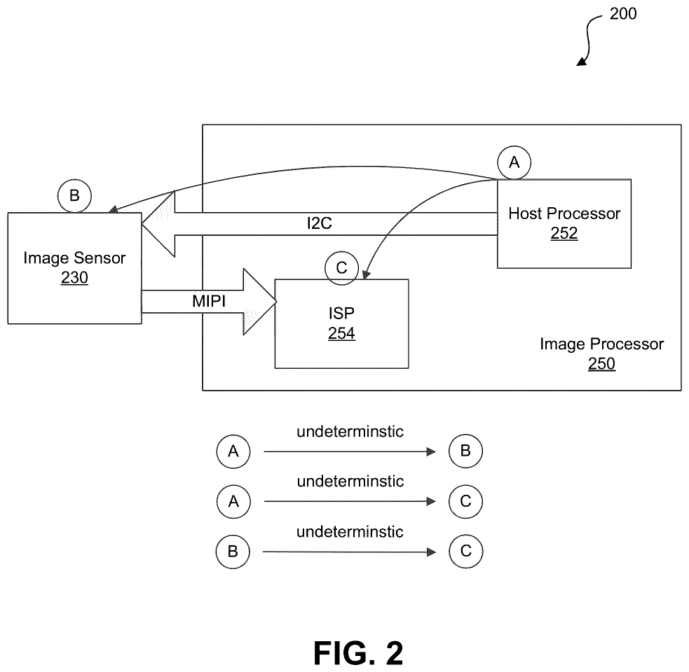

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

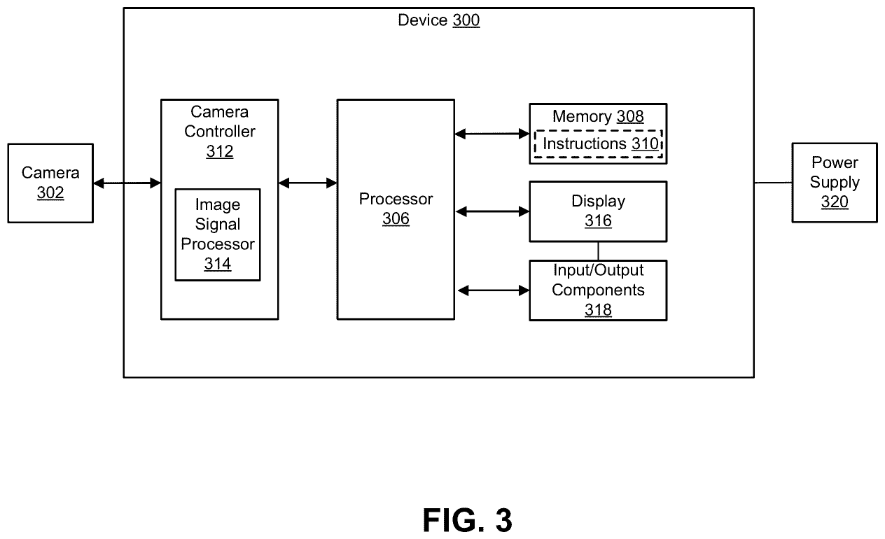

FIG. 3 is a block diagram of an example device 300 that may be used for post AEC and AWB processing to improve video quality. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

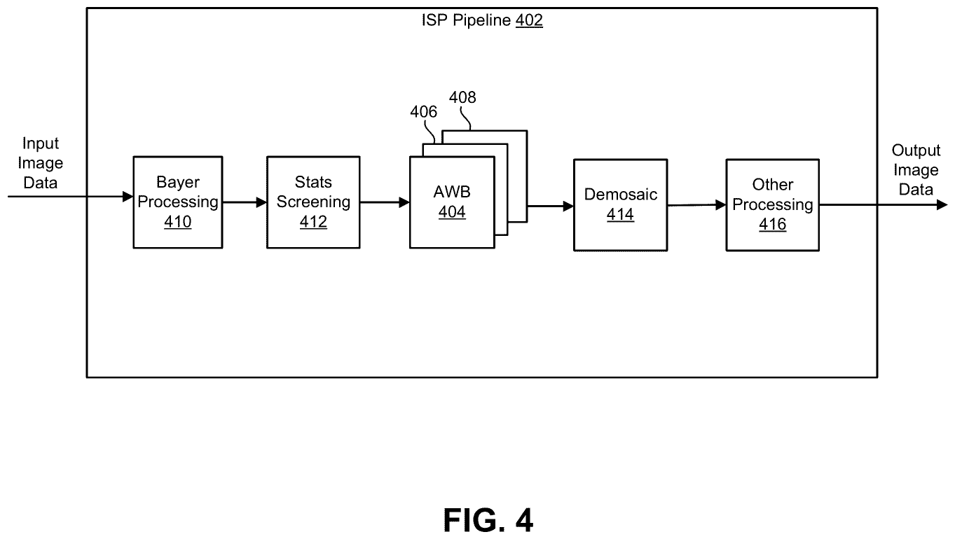

FIG. 4 is a block diagram showing the operation of an image signal processing pipeline 402 of an image signal processor (e.g., the ISP 314). For example, the ISP 314 may be configured to execute the image signal processing pipeline 402 to process input image data. The ISP 314 may receive the input image data from camera 302 of FIG. 3 and/or an image sensor (not shown) of camera 302. In some examples, such as shown in FIG. 4, the input image data may include color data of the image/frame and/or any other data (e.g., depth data). In the example of FIG. 4, the color data received for the input image data may be in a Bayer format. Rather than capturing red (R), green (G), and blue (B) values for each pixel of an image, image sensors (e.g., an image sensor of camera 302) may use a Bayer filter mosaic (or more generally, a color filter array (CFA)), where each photosensor of a digital image sensor captures a different one of the RGB colors. One example of a filter pattern for a Bayer filter mosaic may include 50% green filters, 25% red filters, and 25% blue filters.

Bayer processing unit 410 may perform one or more initial processing techniques on the raw Bayer data received by ISP 314, including, for example, subtraction, rolloff correction, bad pixel correction, black level compensation, and/or denoising.

Statistics (stats) screening process 412 may determine Bayer grade or Bayer grid (BG) statistics of the received input image data. In some examples, BG statistics may include a red color to green color ratio (R/G) (which may indicate whether a red tinting exists and the magnitude of the red tinting that may exist in an image) and/or a blue color to green color ratio (B/G) (which may indicate whether a blue tinting exists and the magnitude of the blue tinting that may exist in an image). For example, the (R/G) for an image or a portion/region of an image may be depicted by equation (1) below:

$$R / G = \frac{{\sum }_{n = 1}^{N} Red ( n )}{{\sum }_{n = 1}^{N} Green ( n )} \qquad ( 1 )$$

where the image or a portion/region of the image includes pixels 1-N, each pixel n includes a red value Red (n), a blue value Blue (n), or a green value Green (n) in an RGB space. The (R/G) is the sum of the red values for the red pixels in the image divided by the sum of the green values for the green pixels in the image. Similarly, the (B/G) for the image or a portion/region of the image may be depicted by equation (2) below:

$$B / G = \frac{{\sum }_{n = 1}^{N} Blue ( n )}{{\sum }_{n = 1}^{N} Green ( n )} \qquad ( 2 )$$

In some other example implementations, a different color space may be used, such as Y′UV, with chrominance values UV indicating the color, and/or other indications of a tinting or other color temperature effect for an image may be determined.

AWB module and/or process 404 may analyze information relating to the received image data to determine an illuminant of the scene, from among a plurality of possible illuminants, and may determine an AWB gain to apply to the received image and/or a subsequent image based on the determined illuminant. White balance is a process used to try to match colors of an image with a user's perceptual experience of the object being captured. As an example, the white balance process may be designed to make white objects actually appear white in the processed image and gray objects actually appear gray in the processed image.

An illuminant may include a lighting condition, a type of light, etc. of the scene being captured. In some examples, a user of an image capture device (e.g., such as device 300 of FIG. 3) may select or indicate an illuminant under which an image was captured. In other examples, the image capture device itself may automatically determine the most likely illuminant and perform white balancing based on the determined illuminant (e.g., lighting condition). In order to better render the colors of a scene in a captured image or video, an AWB algorithm on a device and/or camera may attempt to determine the illuminants of the scene and set/adjust the white balance of the image or video accordingly.

Device 300, during the AWB process 404, may determine or estimate a color temperature for a received frame (e.g., image). The color temperature may indicate a dominant color tone for the image. The true color temperature for a scene being captured in a video or image is the color of the light sources for the scene. If the light is radiation emitted from a perfect blackbody radiator (theoretically ideal for all electromagnetic wavelengths) at a particular color temperature (represented in Kelvin (K)), and the color temperatures are known, then the color temperature for the scene is known. For example, in a Commission Internationale de l'éclairage (CIE) defined color space (from 1931), the chromaticity of radiation from a blackbody radiator with temperatures from 1,000 to 20,000 K is the Planckian locus. Colors on the Planckian locus from approximately 2,000 K to 20,000 K are considered white, with 2,000 K being a warm or reddish white and 20,000 K being a cool or bluish white. Many incandescent light sources include a Planckian radiator (tungsten wire or another filament to glow) that emits a warm white light with a color temperature of approximately 2,400 to 3,100 K.

However, other light sources, such as fluorescent lights, discharge lamps, or light emitting diodes (LEDs), are not perfect blackbody radiators whose radiation falls along the Planckian locus. For example, an LED or a neon sign emit light through electroluminescence, and the color of the light does not follow the Planckian locus. The color temperature determined for such light sources may be a correlated color temperature (CCT). The CCT is the estimated color temperature for light sources whose colors do not fall exactly on the Planckian locus. For example, the CCT of a light source is the blackbody color temperature that is closest to the radiation of the light source. CCT may also be denoted in K.

CCT may be an approximation of the true color temperature for the scene. For example, the CCT may be a simplified color metric of chromaticity coordinates in the CIE 1931 color space. Many devices may use AWB to estimate a CCT for color balancing.

The CCT may be a temperature rating from warm colors (such as yellows and reds below 3200 K) to cool colors (such as blue above 4000 K). The CCT (or other color temperature) may indicate the tinting that will appear in an image captured using such light sources. For example, a CCT of 2700 K may indicate a red tinting, and a CCT of 5000 K may indicate a blue tinting.

Different lighting sources or ambient lighting may illuminate a scene, and the color temperatures may be unknown to the device. As a result, the device may analyze data captured by the image sensor to estimate a color temperature for an image (e.g., a frame). For example, the color temperature may be an estimation of the overall CCT of the light sources for the scene in the image. The data captured by the image sensor used to estimate the color temperature for a frame (e.g., image) may be the captured image itself.

After device 300 determines a color temperature for the scene (such as during performance of AWB), device 300 may use the color temperature to determine a color balance for correcting any tinting in the image. For example, if the color temperature indicates that an image includes a red tinting, device 300 may decrease the red value or increase the blue value for each pixel of the image, e.g., in an RGB space. The color balance may be the color correction (such as the values to reduce the red values or increase the blue values).

Example inputs to AWB process 404 may include the Bayer grade or Bayer grid (BG) statistics of the received image data determined via statistics screening process 412, an exposure index (e.g., the brightness of the scene of the received image data), and auxiliary information, which may include the contextual information of the scene based on the audio input (as will be discussed in further detail below), depth information, etc. It should be noted that AWB process 404 may be included within camera controller 312 of FIG. 3 as a separate AWB module.

AE process 406 may include instructions for configuring, calculating, and/or storing an exposure setting of camera 302 of FIG. 3. An exposure setting may include an amount of sensor gain to be applied, an amount of digital gain to be applied, shutter speed and/or exposure time, an aperture setting, and/or an ISO setting to use to capture subsequent images. AE process 406 may use the audio input and/or the contextual information of the scene based on the audio input to determine and/or apply exposure settings faster. It should be noted that AE process 406 may be included within camera controller 312 of FIG. 3 as a separate AE module.

AF process 408 may include instructions for configuring, calculating and/or storing an auto focus setting of camera 302 of FIG. 3. AF process 408 may determine the auto focus setting (e.g., an initial lens position, a final lens position, etc.) based on the audio input and/or the contextual information of the scene based on the audio input. It should be noted that AF process 408 may be included within camera controller 312 of FIG. 3 as a separate AF module.

Demosaic processing unit 414 may be configured to convert the processed Bayer image data into RGB values for each pixel of an image. As explained above, Bayer data may only include values for one color channel (R, G, or B) for each pixel of the image. Demosaic processing unit 414 may determine values for the other color channels of a pixel by interpolating from color channel values of nearby pixels. In some ISP pipelines 402, demosaic processing unit 414 may come before AWB, AE, and/or AF processes 404, 406, 408 or after AWB, AE, and/or AF processes 404, 406, 408.

Other processing unit 416 may apply additional processing to the image after AWB, AE, and/or AF processes 404, 406, 408 and/or demosaic processing unit 414. The additional processing may include color, tone, and/or spatial processing of the image.

As previously mentioned, for image processing, for example by an image processor (e.g., the ISP 154 of FIG. 1, ISP 254 of FIG. 2, and/or ISP 314 of FIGS. 3 and 4), an AWB (e.g., an AWB module, which may be located within camera controller 312 of FIG. 3) can also be utilized in image processing (e.g., by the image processor) to determine the AWB gain for an image, which can determine the neutral color of the image. The goal of an AWB is to make the color of the image (e.g., of an image frame) balanced with respect to a reference white point.

In existing image processing solutions, traditional AWB algorithms typically employ a statistics-based algorithm to perform automatic white balance.

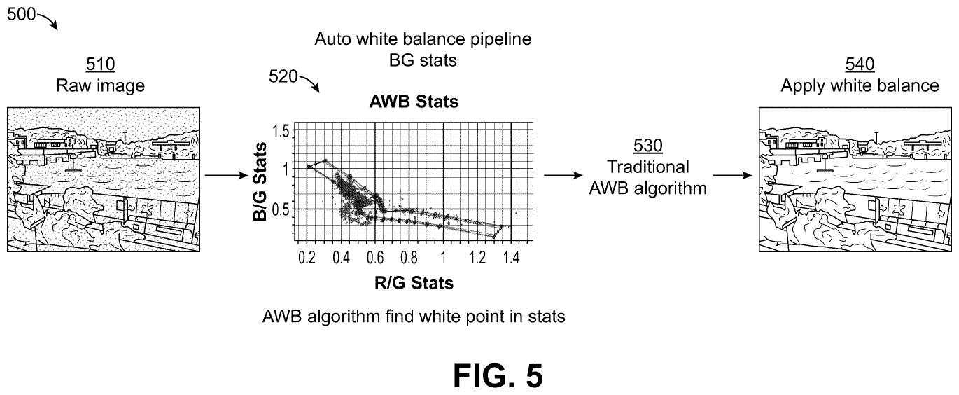

FIG. 5 shows an example of a traditional AWB algorithm. In particular, FIG. 5 is a diagram illustrating an example process 500 of a traditional AWB algorithm 530. In FIG. 5, a raw image 510 (e.g., obtained by a camera sensor of a camera device) is shown to be processed by one or more processors utilizing a traditional AWB algorithm 530.

In one or more examples during operation of the process 500, one or more processors (e.g., of the camera device), running a traditional AWB algorithm 530, can use a statistics-based graph 520 to find a white balance point. In one or more examples, in the statistics-based graph 520, the x-axis can denote R/G statistics (stats), and the y-axis can denote B/G stats. The one or more processors can determine a white balance gain based on the white balance point. The one or more processors can then apply the white balance gain to the raw image 510 to produce the resultant image 540.

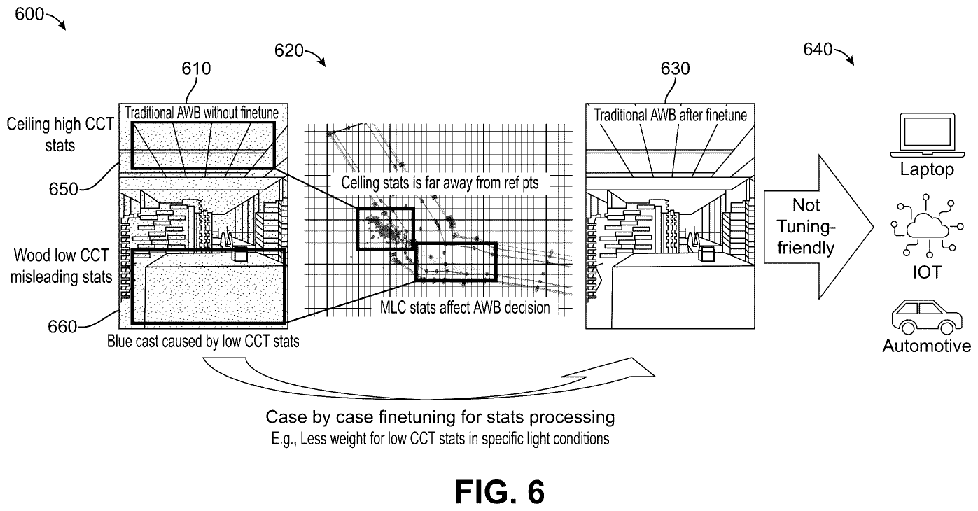

However, the traditional AWB algorithms (e.g., such as traditional AWB algorithm 530 of FIG. 5) require cumbersome finetuning (e.g., which can consume many resources) of the AWB algorithm parameters to obtain quality white balancing in every single different scene. FIG. 6 is a diagram illustrating an example process 600 of a traditional AWB algorithm with cumbersome finetuning. In FIG. 6, the image 610 is a resultant image produced by a traditional AWB algorithm without the use of finetuning. In the image 610, a region 650 including a ceiling of the scene is shown to have high CCT stats, and a region 660 including a table within the scene is shown to have low CCT stats (e.g., causing a blue cast within the region 660.

One or more processors (e.g., of the camera device), running a traditional AWB algorithm, can use a statistics-based graph 620 to determine a white balance gain. Ceiling stats for the region 650 are shown in the graph 620 to be located far away from reference points. The machine learning stats (e.g., shown in the graph 620) can affect the AWB decision. The one or more processors can finetune (e.g., on a case by case basis, such as by giving less weight to CCT stats in specific lighting conditions) the stats of the graph 620 to determine the white balance gain. The one or more processors can then apply the white balance gain to produce the resultant image 630.

Currently, more and more manufacturers of many different types of products 640 (e.g., laptop computers, IoT devices, and/or automotive vehicles) desire AWB solutions that need less tuning to achieve the same quality of white balancing. Due to a sensitivity difference in the different types of camera sensors (e.g., image sensors), no single ML model of these existing AWB algorithms can effectively process raw images captured from all different types of camera sensors. For these traditional AWB algorithms, the ML models (e.g., which use raw images as an input) have the disadvantage of requiring retraining for each of the different types of camera sensors.

A traditional AWB algorithm can obtain a quality white balance result if the ML model is well trained. However, the ML model trained with raw data (e.g., raw images) is dependent upon the type of camera sensor (e.g., that obtained the raw data). As such, when there is a change in the type of camera sensor used to obtain the raw data (e.g., raw image), the ML model will need to be retrained.

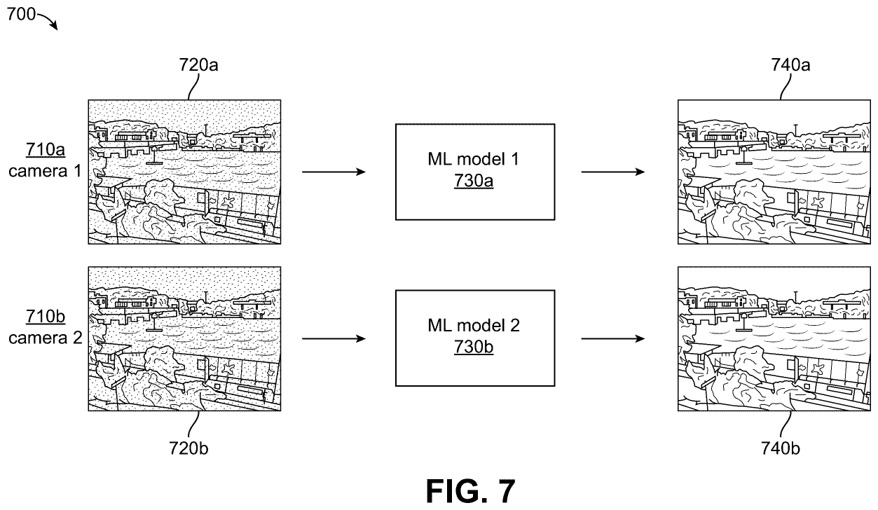

FIG. 7 shows an example of a traditional AWB algorithm needing to retrain an ML model for different types of camera sensors. In particular, FIG. 7 is a diagram illustrating an example of a process 700 of a traditional AWB algorithm utilizing an ML model that is camera sensor (e.g., image sensor) dependent. In FIG. 7, a first type of camera sensor (e.g., camera 1 710a) and a second type of camera sensor (e.g., camera 2 710b) are shown. Camera 1 710a can obtain a first raw image 720a of a scene, and camera 2 710b can obtain a second raw image 720b of the same scene.

The traditional AWB algorithm can use a first ML model 1 730a, which uses the first raw image 720a as an input, to obtain a first white balance gain for the first raw image 720a of the scene. The first ML model 1 730a has been trained with raw images obtained (e.g., captured) by the first type of camera sensor (e.g., the first type of image sensor). After the first white balance gain for the first raw image 720a is determined, the first white balance gain for the first raw image 720a can be applied to the first raw image 720a to obtain a first resultant image 740a.

For the second raw image 720b, the first ML model 1 730a will need to be retrained with raw images obtained (e.g., captured) by the second type of camera sensor (e.g., a second type of image sensor) to produce a second ML model 2 730b. The traditional AWB algorithm can then use the second ML model 2 730b, which uses the first raw image 720b as an input, to obtain an accurate second white balance gain for the second raw image 720b of the scene. After the second white balance gain for the second raw image 720b is determined, the second white balance gain for the second raw image 720b can be applied to the second raw image 720b to obtain a second resultant image 740b.

Since traditional AWB algorithms use ML models that need to be retrained for each different type of camera sensor, improved systems and techniques for AWB that employ a universal ML model, which can be used for all different types of camera sensors and does not need to be retrained for each of the different types of camera sensors, can be useful.

In one or more aspects, the systems and techniques provide a universal AI AWB. In one or more examples, the systems and techniques provide an AWB solution that eliminates the dependency between the ML model and the type of camera sensor (e.g., image sensor). In some examples, RGB images may be used to train an ML model. The ML model may generate a predicted result that can be converted back to produce a WB gain. By training the ML model with RGB images, the ML model can universally be employed for all different types of camera sensors (e.g., without requiring retraining of the ML model for the different types of camera sensors).

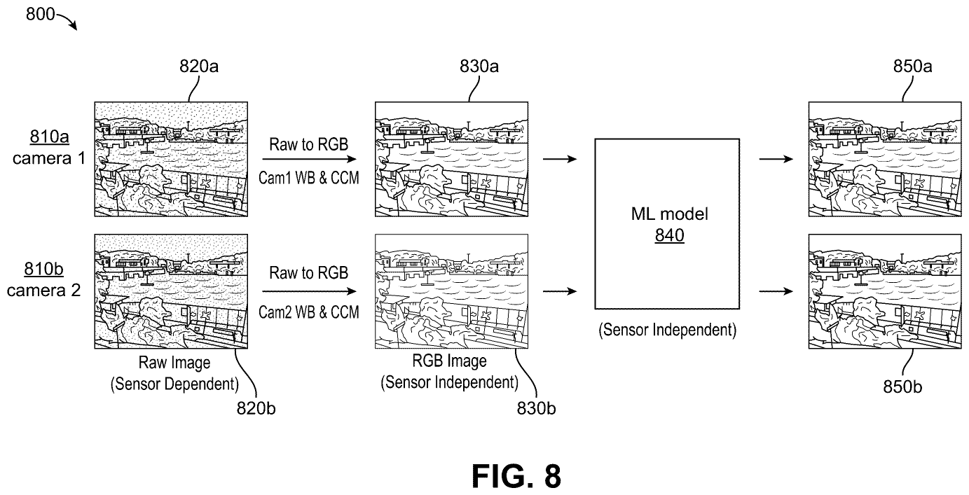

FIG. 8 shows an example of operation of a universal AI AWB algorithm. In particular, FIG. 8 is a diagram illustrating an example of a process 800 of a universal AI AWB algorithm. In FIG. 8, a first type of camera sensor (e.g., camera 1 810a) and a second type of camera sensor (e.g., camera 2 810b) are shown. Camera 1 810a can obtain a first raw image 820a of a scene, and camera 2 810b can obtain a second raw image 820b of the same scene.

One or more processors running the universal AI AWB algorithm can convert, by applying a white balance and a CCM associated with camera 1 810a, the first raw image 820a to a first RGB image 830a. The one or more processors running the universal AI AWB algorithm, can convert, by applying a white balance and a CCM associated with camera 2 810b, the second raw image 820b to a second RGB image 830b.

The universal AI AWB algorithm can use an ML model 840, which uses the RGB images 830a, 830b as an input, to obtain a first white balance gain for the first raw image 820a of the scene and a second white balance gain for the second raw image 820b of the scene. The ML model 840 has been trained with raw images obtained (e.g., captured) by the first type of camera sensor (e.g., a first type of image sensor) and with raw images obtained (e.g., captured) by the second type of camera sensor (e.g., a second type of image sensor). As such, the ML model 840 is camera sensor (e.g., image sensor) independent. In one or more examples, the raw images captured can be raw images with different lighting conditions (e.g., having different lux indexes). In some examples, the training of the ML model 840 may be a supervised training.

After the first white balance gain for the first raw image 820a is determined by the ML model 840, the first white balance gain for the first raw image 820a can be applied to the first raw image 820a to obtain a first resultant image 850a. After the second white balance gain for the second raw image 820b is determined by the ML model 840, the second white balance gain for the second raw image 820b can be applied to the second raw image 820b to obtain a second resultant image 850b.

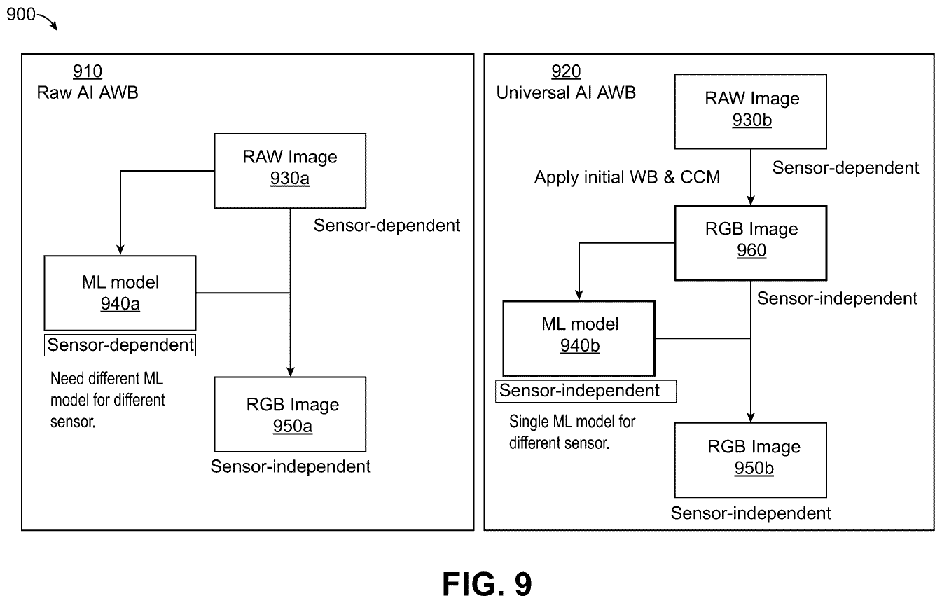

FIG. 9 shows an example comparison of a traditional AWB algorithm and a universal AI AWB algorithm. In particular, FIG. 9 is a diagram illustrating a comparison 900 between a traditional AWB algorithm 910 (e.g., a raw AI AWB) and a universal AI AWB algorithm 920. In FIG. 9, for the traditional AWB algorithm 910, a raw image 930a of a scene can be obtained (e.g., captured) by a camera sensor (e.g., an image sensor). An ML model 940a (e.g., a camera sensor dependent ML model) of the traditional AWB algorithm 910 is shown to use the raw image 930a of a scene as an input. The ML model 940a has been pretrained using raw images from the type of camera sensor that obtained the raw image 930a. Based on the raw image 930a of the scene, the ML model 940a can generate a white balance gain for the raw image 930a. The generated white balance gain can then be applied to the raw image 930a to obtain a resultant RGB image 950a.

For the universal AI AWB algorithm 920 of FIG. 9, a raw image 930b of a scene can be obtained (e.g., captured) by a camera sensor (e.g., an image sensor). The raw image 930b can be converted to a RGB image 960 for the scene. An ML model 940b (e.g., a camera sensor independent ML model) of the universal AI AWB algorithm 920 is shown to use the RGB image 960 of a scene as an input. The ML model 960 has been pretrained using raw images from various different types of camera sensors, including the types of camera sensor that obtained the raw image 930b. Based on the RGB image 960 of the scene, the ML model 94b can generate a white balance gain for the raw image 930b. The generated white balance gain can then be applied to the raw image 930b to obtain a resultant RGB image 950b.

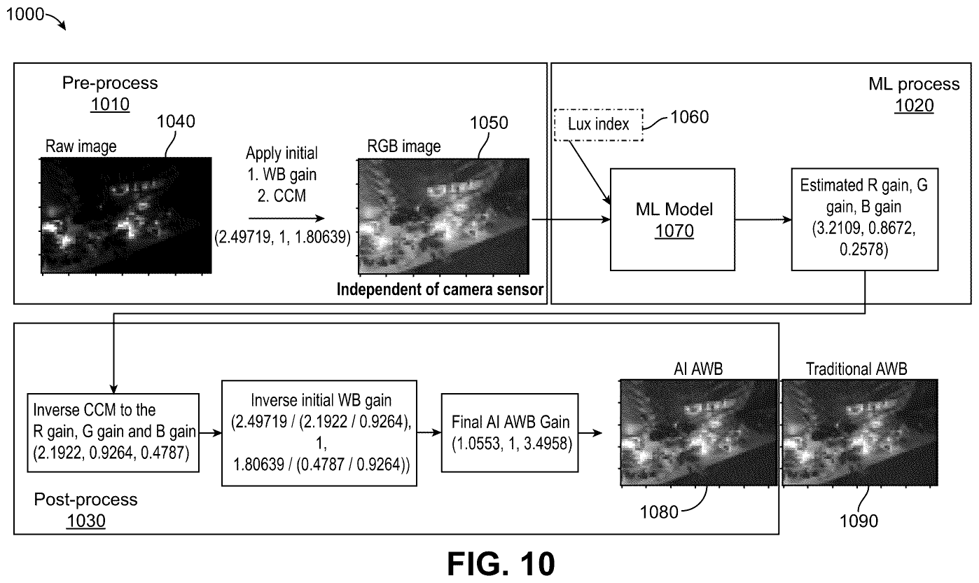

FIG. 10 shows a detailed example of operation of a universal AI AWB algorithm. In particular, FIG. 10 is a diagram illustrating an example of a detailed process 1000 of a universal AI AWB algorithm. In FIG. 10, the process 1000 is shown to include three sub-processes, which include a pre-process 1010 (e.g., used to convert a raw image of a scene to a RGB image (or bayer-grid stats)), an ML process 1020 (e.g., used to estimate a WB cast (e.g., an estimated gain of at least one color component) based on the RGB image), and a post-process 1030 (e.g., used to inverse the WB cast using an initial color correction matrix (CCM) and an initial WB gain to determine a resultant WB gain).

In one or more examples, during operation of the pre-process 1010 of the process 1000, an image sensor (e.g., of a camera device) can obtain a raw image 1040 of a scene. One or more processors (e.g., of the camera device, such as processors 1310 of FIG. 13) can apply an initial white balance (WB) gain and an initial color correction matrix (CCM) to the raw image 1040 of the scene to produce (e.g., to transform the raw image 1040 to) a color image (e.g., an RGB image 1050 or bayer-grid stats). The transforming of the raw image 1040 (e.g., sensor dependent) to the RGB image 1050 (e.g., a sensor independent) also transforms a sensor-dependent domain to a non-sensor dependent domain.

In one or more examples, an initial R gain, G gain, and B gain can be associated with the initial WB gain. For example, the initial R gain can equal 2.49719, the initial G gain can equal 1, and the initial B gain can equal 1.80639. In one or more examples, the initial CCM can be a three by three matrix.

In one or more examples, the initial WB gain and the initial CCM can be associated with the camera sensor (e.g., image sensor) that obtained the raw image 1040. In some examples, the initial WB gain and the initial CCM can be associated with an illuminance (Lux) index (e.g., which can correspond to an illuminance of the raw image 1040). In one or more examples, the initial WB gain and the initial CCM can be determined from data calibrated in advance in multiple different lighting conditions and/or from an output of a traditional non-ML algorithm.

In some examples, a WB gain can be a multiplier that can applied to the red, green, and blue channels of an image. The WB gain can be used to adjust the color temperature of an image such that the white objects within the image appear white under different lighting conditions. In one or more examples, the CCM can be a mathematical transformation that can map the colors in an image from one color space to another color space. The CCM can be used to correct color inaccuracies in an image caused by factors, such as lighting conditions, camera setting, and sensor characteristics. In one or more examples, the color image can be a red, green, blue (RGB) image. In some examples, the RGB image has a red component, a green component, and a blue component per pixel of the image.

In one or more examples, during operation of the ML process 1020 of the process 1000, the one or more processors, using a machine learning model 1070, can generate an estimated gain of at least one color component (R, G, B) based on the color image (e.g., RGB image 1050). In one or more examples, the estimated gain can be further based on an illuminance (lux) index 1060 for the raw image 1040 to provide environment brightness information. In some examples, the estimated gain of the at least one color component can include a red gain (e.g., 3.2109), a green gain (e.g., 0.8672), and a blue gain (e.g., 0.2578) based on the RGB image 1050. The RGB gains can be estimated based on the RGB domain.

In some examples, during operation of the post-process 1030 of the process 1000, the one or more processors can determine a resultant WB gain. In one or more examples, the resultant WB gain can be obtained by transferring the estimated gain of the at least one color component from RGB domain back to the raw domain (e.g., which is sensor dependent). The pre-process 1010 can then be reversed by applying an inverse of the CCM to the estimated gains, which can be used to obtain the resultant WB gain.

The one or more processors can determine a resultant WB gain based on an inverse of the initial WB gain. The one or more processors can determine the inverse of the initial WB gain based on the initial WB gain divided by an inverse of the CCM applied to the estimated gain of the at least one color component. In one or more examples, the inverse of the initial WB gain can be determined to be equal to (2.49719/(2.1922/0.9264), (1/(0.9264/0.9264)), (1.80639/(0.4787/0.9264), which is equal to 1.0553, 1, 3.4958).

In some examples, the initial WB gain can be associated with initial RGB gains (e.g., initial R gain equal to 2.49719, initial G gain equal to 1, and initial B gain equal to 1.80639). The resultant WB gain can be associated with resultant RGB gains (e.g., resultant R gain equal to 1.0553, resultant G gain equal to 1, resultant B gain equal to 3.4958). The one or more processors can apply the resultant WB gain to the raw image 1040 to produce a resultant image 1080. A display can display the resultant image 1080. In one or more examples, the resultant image 1080 produced using the universal AI AWB algorithm is shown to be comparable to a resultant image 1090 produced using a traditional AWB algorithm.

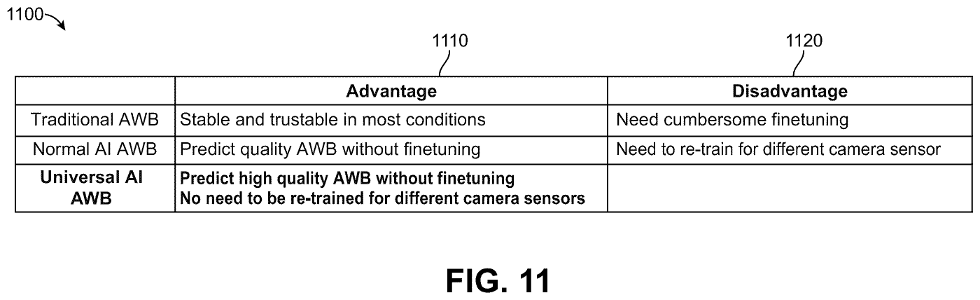

FIG. 11 is a table 1100 illustrating a comparison of advantages 1110 and disadvantages 1120 of traditional AWB algorithms, normal AI AWB algorithms, and universal AI AWB algorithms. In FIG. 11, the table 1100 shows that the traditional AWB algorithms have advantages 1110 of being stable and trustable in most conditions, and have a disadvantage 1120 of needing cumbersome finetuning. The table 1100 also shows that the normal AI AWB algorithms have the advantage 1110 of being able to predict good AWB without the use of finetuning, and the disadvantage 1120 of needing to be retrained for each different camera sensor. The table 1100 additionally shows that the universal AI AWB algorithms have the advantages 1110 of being able to predict good AWB without the use of finetuning and not needing to be retrained for each of the different camera sensors. The table 1100 does not show any known disadvantages 1120 for the universal AI AWB algorithms.

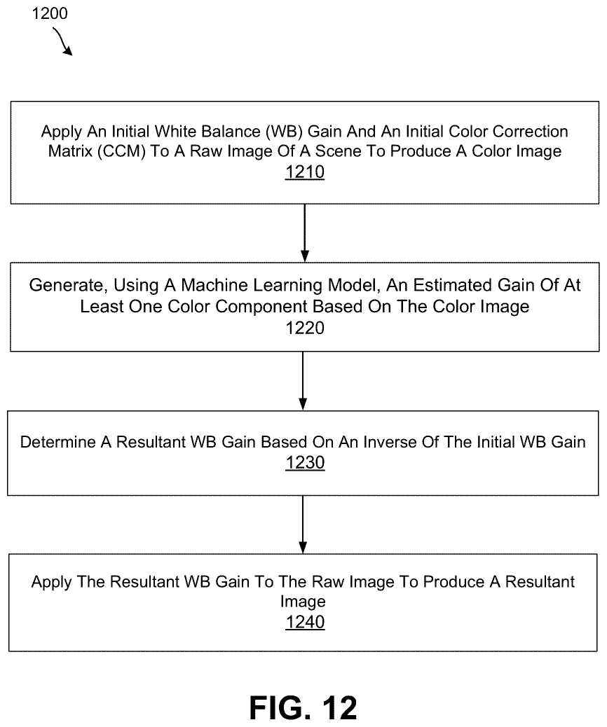

FIG. 12 is a flow chart illustrating an example of a process 1200 for image processing. The process 1200 can be performed by a computing device (e.g., the ISP 154 of FIG. 1, ISP 254 of FIG. 2, and/or ISP 314 of FIGS. 3 and 4, and/or a computing device or computing system 1300 of FIG. 13) or by a component or system (e.g., a chipset, one or more processors such as one or more central processing units (CPUs), neural processing units (NPUs), neural signal processors (NSPs), digital signal processors (DSPs), graphics processing units (GPUs), any combination thereof, and/or other type of processor(s), or other component or system) of the computing device. The operations of the process 1200 may be implemented as software components that are executed and run on one or more processors (e.g., image processor 150 of FIG. 1, the image signal processor 314 and/or the processor 306 of FIG. 3, a processor such as an ISP configured to implement the ISP pipeline 402 of FIG. 4, processor 1310 of FIG. 13 or other processor(s)). Further, the transmission and reception of signals by the computing device in the process 1200 may be enabled, for example, by one or more antennas and/or one or more transceivers (e.g., wireless transceiver(s)).

At block 1210, the computing device (or component thereof) can apply an initial white balance (WB) gain and an initial color correction matrix (CCM) to a raw image of a scene (e.g., raw image 1040 of FIG. 10) to produce a color image. In some cases, the color image is a red, green, blue (RGB) image (e.g., the RGB image 1050 of FIG. 10). In some cases, the computing device (or component thereof) can obtain the raw image of the scene from an image sensor (e.g., the image sensor 130 of FIG. 1). In some aspects, the initial WB gain and the initial CCM are associated with the image sensor. In some cases, the initial WB gain and the initial CCM are associated with an illuminance index (e.g., a lux index).

At block 1220, the computing device (or component thereof) can generate, using a machine learning model (e.g., the ML model 940b of FIG. 9, the ML model 1070 of FIG. 10, etc.), an estimated gain of at least one color component based on the color image. In some aspects, the computing device (or component thereof) can generate the estimated gain further based on an illuminance index (e.g., the lux index 1060 of FIG. 10) for the raw image. In one illustrative example, when the color image is an RGB image, the estimated gain of the at least one color component comprises a red gain, a green gain, and a blue gain based on the RGB image.

At block 1230, the computing device (or component thereof) can determine a resultant WB gain (e.g., the final AI AWB gain shown in FIG. 10) based on an inverse of the initial WB gain. In some aspects, the computing device (or component thereof) can determine the inverse of the initial WB gain based on the initial WB gain divided by an inverse of the CCM applied to the estimated gain of the at least one color component (e.g., as shown in the post-process 1030 of FIG. 10). In some cases, the initial WB gain is associated with initial RGB gains (e.g., the initial R gain of 2.49719, the initial G gain of 1, and the initial B gain of 1.80639 in FIG. 10), and the resultant WB gain is associated with resultant RGB gains (e.g., the resultant R gain of 1.0553, the resultant G gain of 1, and the resultant B gain of 3.4958 in FIG. 10).

At block 1240, the computing device (or component thereof) can apply the resultant WB gain to the raw image to produce a resultant image. In some cases, the computing device (or component thereof) can display, via a display (e.g., which may be part of the computing device), the resultant image. In some cases, the computing device (or component thereof) can store the resultant image in storage, such as in at least one memory (e.g., the RAM 140 and/or the ROM 145 of FIG. 1, the memory 308 of FIG. 3, the memory 1315, the cache 1312, the ROM 1320, and/or the RAM 1325 of FIG. 13).

In some cases, the computing device of process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1200 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed for a universal artificial intelligence (AI) automatic white balance (AWB). In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LIDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: apply an initial white balance (WB) gain and an initial color correction matrix (CCM) to a raw image of a scene to produce a color image; generate, using a machine learning model, an estimated gain of at least one color component based on the color image; determine a resultant WB gain based on an inverse of the initial WB gain; and apply the resultant WB gain to the raw image to produce a resultant image.

Aspect 2. The apparatus of Aspect 1, wherein the at least one processor is configured to obtain, from an image sensor, the raw image of the scene.

Aspect 3. The apparatus of Aspect 2, wherein the initial WB gain and the initial CCM are associated with the image sensor.

Aspect 4. The apparatus of any one of Aspects 2 or 3, wherein the initial WB gain and the initial CCM are associated with an illuminance index.

Aspect 5. The apparatus of any one of Aspects 1 to 4, wherein the at least one processor is configured to generate the estimated gain further based on an illuminance index for the raw image.

Aspect 6. The apparatus of any one of Aspects 1 to 5, wherein the at least one processor is configured to determine the inverse of the initial WB gain based on the initial WB gain divided by an inverse of the CCM applied to the estimated gain of the at least one color component.

Aspect 7. The apparatus of any one of Aspects 1 to 6, wherein the initial WB gain is associated with initial RGB gains, and wherein the resultant WB gain is associated with resultant RGB gains.

Aspect 8. The apparatus of any one of Aspects 1 to 7, wherein the color image is a red, green, blue (RGB) image.

Aspect 9. The apparatus of Aspect 8, wherein the estimated gain of the at least one color component comprises a red gain, a green gain, and a blue gain based on the RGB image.

Aspect 10. The apparatus of any one of Aspects 1 to 9, further comprising a display configured to display the resultant image.

Aspect 11. A method of image processing, the method comprising: applying an initial white balance (WB) gain and an initial color correction matrix (CCM) to a raw image of a scene to produce a color image; generating, using a machine learning model, an estimated gain of at least one color component based on the color image; determining a resultant WB gain based on an inverse of the initial WB gain; and applying the resultant WB gain to the raw image to produce a resultant image.

Aspect 12. The method of Aspect 11, further comprising obtaining, by an image sensor, the raw image of the scene.

Aspect 13. The method of Aspect 12, wherein the initial WB gain and the initial CCM are associated with the image sensor.

Aspect 14. The method of any one of Aspects 12 or 13, wherein the initial WB gain and the initial CCM are associated with an illuminance index.

Aspect 15. The method of any one of Aspects 11 to 14, wherein generating the estimated gain is further based on an illuminance index for the raw image.

Aspect 16. The method of any one of Aspects 11 to 15, further comprising determining the inverse of the initial WB gain based on the initial WB gain divided by an inverse of the CCM applied to the estimated gain of the at least one color component.

Aspect 17. The method of any one of Aspects 11 to 16, wherein the initial WB gain is associated with initial RGB gains, and wherein the resultant WB gain is associated with resultant RGB gains.

Aspect 18. The method of any one of Aspects 11 to 17, wherein the color image is a red, green, blue (RGB) image.

Aspect 19. The method of Aspect 18, wherein the estimated gain of the at least one color component comprises a red gain, a green gain, and a blue gain based on the RGB image.

Aspect 20. The method of any one of Aspects 11 to 19, further comprising displaying, by a display, the resultant image.

Aspect 21. A non-transitory computer-readable medium having stored thereon instructions that, when executed by one or more processors, cause the one or more processors to perform operations according to any of Aspects 11 to 20.

Aspect 22. An apparatus for image processing, the apparatus including one or more means for performing operations according to any of Aspects 11 to 20.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus of image processing, the apparatus comprising:
at least one memory; and
at least one processor coupled to the at least one memory and configured to:
apply an initial white balance (WB) gain and an initial color correction matrix (CCM) to a raw image of a scene to produce a color image;
generate, using a machine learning model, an estimated gain of at least one color component based on the color image;
determine a resultant WB gain based on an inverse of the initial WB gain; and
apply the resultant WB gain to the raw image to produce a resultant image.

2. The apparatus of claim 1, wherein the at least one processor is configured to obtain, from an image sensor, the raw image of the scene.

3. The apparatus of claim 2, wherein the initial WB gain and the initial CCM are associated with the image sensor.

4. The apparatus of claim 2, wherein the initial WB gain and the initial CCM are associated with an illuminance index.

5. The apparatus of claim 1, wherein the at least one processor is configured to generate the estimated gain further based on an illuminance index for the raw image.

6. The apparatus of claim 1, wherein the at least one processor is configured to determine the inverse of the initial WB gain based on the initial WB gain divided by an inverse of the CCM applied to the estimated gain of the at least one color component.

7. The apparatus of claim 1, wherein the initial WB gain is associated with initial RGB gains, and wherein the resultant WB gain is associated with resultant RGB gains.

8. The apparatus of claim 1, wherein the color image is a red, green, blue (RGB) image.

9. The apparatus of claim 8, wherein the estimated gain of the at least one color component comprises a red gain, a green gain, and a blue gain based on the RGB image.

10. The apparatus of claim 1, further comprising a display configured to display the resultant image.

11. A method of image processing, the method comprising:
applying an initial white balance (WB) gain and an initial color correction matrix (CCM) to a raw image of a scene to produce a color image;
generating, using a machine learning model, an estimated gain of at least one color component based on the color image;
determining a resultant WB gain based on an inverse of the initial WB gain; and
applying the resultant WB gain to the raw image to produce a resultant image.

12. The method of claim 11, further comprising obtaining, by an image sensor, the raw image of the scene.

13. The method of claim 12, wherein the initial WB gain and the initial CCM are associated with the image sensor.

14. The method of claim 12, wherein the initial WB gain and the initial CCM are associated with an illuminance index.

15. The method of claim 11, wherein generating the estimated gain is further based on an illuminance index for the raw image.

16. The method of claim 11, further comprising determining the inverse of the initial WB gain based on the initial WB gain divided by an inverse of the CCM applied to the estimated gain of the at least one color component.

17. The method of claim 11, wherein the initial WB gain is associated with initial RGB gains, and wherein the resultant WB gain is associated with resultant RGB gains.

18. The method of claim 11, wherein the color image is a red, green, blue (RGB) image.

19. The method of claim 18, wherein the estimated gain of the at least one color component comprises a red gain, a green gain, and a blue gain based on the RGB image.

20. The method of claim 11, further comprising displaying, by a display, the resultant image.
